(19) United States
(12) Patent Application Publication
(10) Pub. No.: US 2016/0299880 A1
(43) Pub. Date: Oct. 13, 2016

(54) METHOD AND DEVICE FOR UPDATING WEB PAGE

(71) Applicant: Tencent Technology (Shenzhen) Comapany Limited, Shenzhen, Guangdong (CN)

(72) Inventor: Zhijian SHEN, Shenzhen, Guangdong (CN)

(73) Assignee: Tencent Technology (Shenzhen) Company Ltd., Shenzhen, Guangdong (CN)

(21) Appl. No.: 14/365,351

(22) PCT Filed: Dec. 3, 2013
(86) PCT No.: PCT/CN2013/088429

§ 371 Date: Jun. 13, 2014

(30) Foreign Application Priority Data
Jan. 30, 2013 (CN) 201310035891.X

(51) Int. Cl. G06F 17/24; G06F 3/0483; G06F 3/0484; G06F 17/22; G06F 17/30

(52) U.S. Cl. CPC G06F 17/24; G06F 17/2247; G06F 17/3089; G06F 3/04847; G06F 3/0483

(57) ABSTRACT

A method and a device for updating a web page are described. The method includes: calling and displaying a structure-editing interface for a page object to perform an edit operation on the page object when receiving an edit request for the page object in the web page; generating, according to a data indicator item included in the structure-editing interface after the edit operation is affirmed, a data entry sheet to input data corresponding to the data indicator item, the data indicator item being used to indicate a data structure of the page object; and denoting the data entry sheet as a new page object to update the page object in the web page when detecting that data input is finished on the data entry sheet.

### CROSS REFERENCE TO RELATED APPLICATIONS

This application claims the benefit of priority from Chinese Patent Application No. 201310035891.X, and filed on Jan. 30, 2013, the content of which is hereby incorporated in its entire by reference.

### FIELD OF THE TECHNICAL

The disclosure relates to the field of web page technology, and particularly to a method and a device for updating a web page.

### BACKGROUND

This section provides background information related to the present disclosure which is not necessarily prior art.

A web page is a document stored in a certain computer or a server, and is a page in a web. After the computer or the server connects with interne, the web page can be displayed on a browser of a user terminal, such as a computer, a smart phone, etc., according to a request of a relevant user.

The web page can include information of text, picture, etc. Multiple page sheets can be included in a web page, and a page object can be set for each of the page sheets. The page object can record information of an object, for example, a certain product, by a corresponding data structure.

In a conventional method, the data structure of an object such as a product generally has a fixed structure. If the structure of the product information changes and needs to be modified, web maintainers can only modify html codes to change the data structure of the product. However, it is easy to cause errors to directly modify the html codes. For example, an html label may not be closed, etc. Thus, it may be inconvenient for the web maintainers to determine the correction of the modified web content, and may be not conducive to the stable operation of a web.

### SUMMARY

Exemplary embodiments of the present invention provide a method and a device for updating a web page, in which a page object can be directly edited and generated for a data structure required by a user to replace and update an original page object, and the risk of causing errors to the web can be efficiently reduced.

One embodiment of the present invention provides a method for updating a web page, comprising: calling and displaying a structure-editing interface for a page object to perform an edit operation on the page object when receiving an edit request for the page object in the web page; generating, according to a data indicator item included in the structure-editing interface after the edit operation is affirmed, a data entry sheet to input data corresponding to the data indicator item, the data indicator item being used to indicate a data structure of the page object; and denoting the data entry sheet as a new page object to update the page object in the web page when detecting that data input is finished on the data entry sheet.

Wherein, the step of generating, according to the data indicator item included in the structure-editing interface after the edit operation is affirmed, the data entry sheet to input the data corresponding to the data indicator item comprises: generating, according to the data indicator item included in the structure-editing interface, a page data structure related to the page object of the web page after detecting that the edit operation is affirmed; introducing the page data structure into a preset objective page sheet and generating the data entry sheet, wherein the data entry sheet displays a data indicator item of the page data structure and an input indicator mark of the data indicator item; and recording an input data from a user which is input in the input indicator mark of the data indicator item displayed on the data entry sheet.

Wherein, the step of introducing the page data structure into a preset objective page sheet and generating the data entry sheet comprises: calling and displaying a page establishing interface; determining the objective page sheet by selecting from at least one preset page sheet module on the page establishing interface; determining the page data structure by selecting from the page establishing interface; and generating the data entry sheet according to the objective page sheet and the page data structure selected on the page establishing interface.

Wherein, the step of calling and displaying the structure-editing interface for a page object to perform the edit operation on the page object when receiving the edit request for the page object in the web page comprises: obtaining a data structure for data included in the page object and the data indicator item for indicating the data structure included in the page object when receiving the edit request for the page object in the web page; and inputting the obtained data indicator item of the page object into the structure-editing interface to perform the edit operation on the data structure of the page object on the structure-editing interface.

Wherein, to perform the edit operation on the data structure of the page object on the structure-editing interface comprises: to perform any one or more of a delete operation, a modification operation, an adding operation on the input data indicator item of the page object on the structure-editing interface.

Wherein, the method further comprises recording information of an editing user of the new page object.

Another embodiment of the present invention provides a device for updating a web page, comprising: a calling module configured to call and display a structure-editing interface for a page object to perform an edit operation on the page object when receiving an edit request for the page object in the web page; a generating module configured to generate, according to a data indicator included in the structure-editing interface after the edit operation is affirmed, a data entry sheet to input data corresponding to the data indicator, the data indicator being used to indicate a data structure of the page object; and a publishing module configured to denote the data entry sheet as a new page object to update the page object in the web page when detecting that data input is finished on the data entry sheet.

Wherein, the generating module comprises: a structure generating unit configured to generate, according to the data indicator included in the structure-editing interface, a page data structure related to the page object of the web page after detecting that the edit operation is affirmed; a page generating unit configured to introduce the page data structure into a preset objective page sheet and generating the data entry sheet, wherein the data entry sheet displays a data indicator item of the page data structure and an input indicator mark of the data indicator item; and a recording unit configured to record an input data from a user which is input in the input indicator mark of the data indicator displayed on the data entry sheet.

Wherein, the page generating unit comprises: a calling sub-unit configured to call and display a page establishing interface; a determining sub-unit configured to determine the objective page sheet by selecting from at least one preset page sheet module on the page establishing interface and the page data structure by selecting from the page establishing interface; and a page generating sub-unit configured to generate the data entry sheet according to the objective page sheet and the page data structure selected on the page establishing interface.

Wherein, the calling module comprises: an obtaining unit configured to obtain a data structure for data included in the page object and the data indicator item for indicating the data structure included in the page object when receiving the edit request for the page object in the web page; and an inputting unit configured to input the obtained data indicator item of the page object into the structure-editing interface to perform the edit operation on the data structure of the page object on the structure-editing interface.

Wherein, to perform an edit operation on the data structure of the page object on the structure-editing interface comprises: to perform any one or more of delete, modification, add operations on the inputted data indicator of the page object on the structure-editing interface.

Wherein, the device further comprises: a recording module configured to record information of an editing user of the new page object.

Exemplary embodiments of the present invention may have the following beneficial effects.

In exemplary embodiments of the present invention, a page sheet of a page object can be directly edited and generated for a data structure required by a user to replace and update an original page sheet, and it is convenient for the web maintainers to edit or modify only one or more page objects in the web page according to needs. Thus, the maintenance cost can be reduced. Moreover, since the risk of causing errors to a web is efficiently reduced, the cost can be further lowered.

### BRIEF DESCRIPTION OF THE DRAWINGS

In order to illustrate the embodiments or existing technical solutions more clearly, a brief description of drawings that assists the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of a method for updating a web page according to one embodiment of the invention;

FIG. 2 is a flowchart of a method for updating a web page according to another embodiment of the invention;

FIG. 3 is a structure diagram of a structure-editing interface for a page object according to one embodiment of the invention;

FIG. 4 is a structure diagram of a page establishing interface according to one embodiment of the invention;

FIG. 5 is a structure diagram of a data entry sheet according to one embodiment of the invention;

FIG. 6 is a structure diagram of an edit-content management page according to one embodiment of the invention;

FIG. 7 is a structure diagram of a device for updating a web page according to one embodiment of the invention;

FIG. 8 is a structure diagram of a device for updating a web page according to another embodiment of the invention.

### DETAILED DESCRIPTION OF ILLUSTRATED EMBODIMENTS

Technical solutions in embodiments of the present invention will be illustrated clearly and entirely with the aid of the drawings in the embodiments of the invention. It is apparent that the illustrated embodiments are only some embodiments of the invention instead of all of them. Other embodiments that a person having ordinary skills in the art obtains based on the illustrated embodiments of the invention without paying any creative work should all be within the protection scope sought by the present invention.

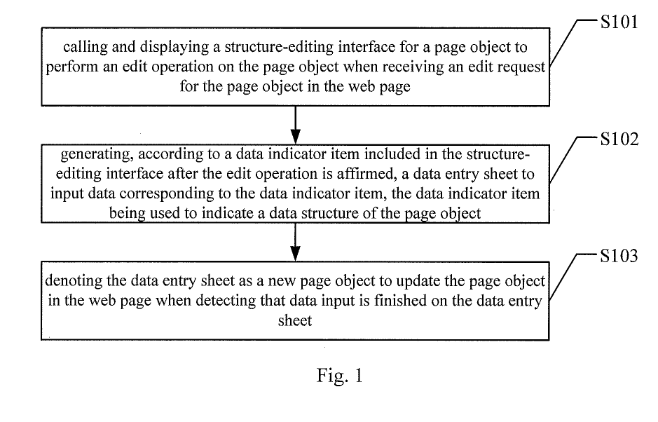

Referring to FIG. 1, it is a flowchart of a method for updating a web page according to one embodiment of the invention. The method can be applied for page maintenance of a web, and particularly to a web in which a data structure of a page object needs to be modified, such as an electronic commerce web, etc. The method comprises the following steps.

Step S101 is: calling and displaying a structure-editing interface for a page object to perform an edit operation on the page object when receiving an edit request for the page object in the web page.

A user may click on a page for editing product content in the web page to select a product to be edited. After the product is selected, an edit request for enabling an edit operation can be received.

The structure-editing interface may be preset, including a name, a data instruction and a specific data indicator item. The specific data indicator item is used to indicate the data structure of the page object. For example, the data indicator item may indicate data as company name data, company link data or the like.

Step S102 is: generating, according to a data indicator item included in the structure-editing interface after the edit operation is affirmed, a data entry sheet to input data corresponding to the data indicator item, the data indicator item being used to indicate a data structure of the page object.

The data entry sheet may include a plurality of data indicators, and each of the data indicators corresponds to an input box which is used to suggest the user to input data. Correspondingly, the user can input a data in the input box, the data being specifically described as information of an object, such as a certain product, and so on. After the input is accomplished, step S103 can be executed.

Step S103 is: denoting the data entry sheet as a new page object to update the page object in the web page when detecting that data input is finished on the data entry sheet.

In step S103, after it is detected that all the input boxes have data input and they have been affirmed by the user clicking an input finish button, it can be determined that accomplishment of data input on the data entry sheet is detected. The data entry sheet may be denoted as a new page object.

Based on the above description, one embodiment of the present invention may have the following benefits.

In exemplary embodiments of the present invention, a page sheet of a page object can be directly edited and generated for a data structure required by a user to replace and update an original page sheet, and it is convenient for the web maintainers to edit or modify only one or more page objects in the web page according to needs. Thus, the maintenance cost can be reduced. Moreover, since the risk of causing errors to a web is efficiently reduced, the cost can be further lowered.

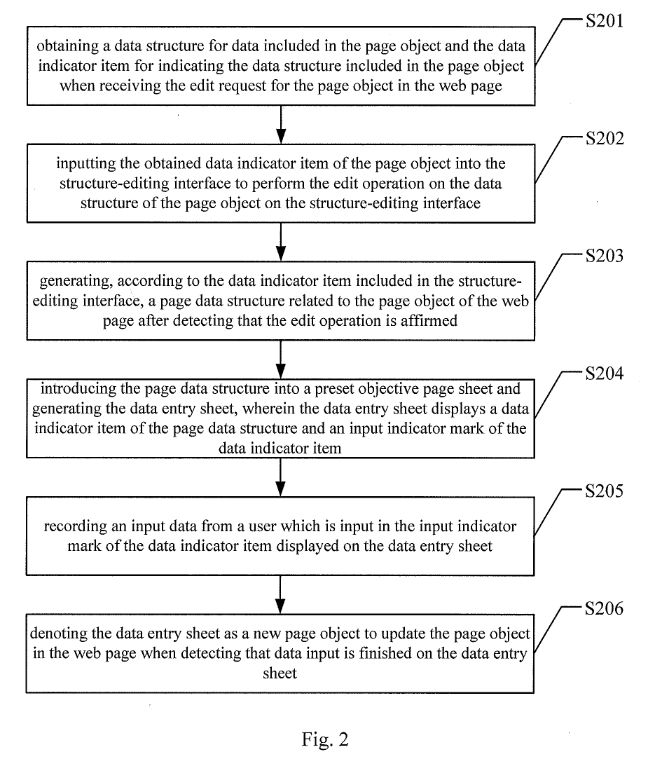

A method for web page updating according to another embodiment of the present invention will be illustrated as below with the aid of FIGS. 2-5

Referring to FIG. 2, it is a flowchart of a method for updating a web page according to another embodiment of the invention. The method can be applied for page maintenance of a web, and particularly to a web in which a data structure of a page object needs to be modified, such as an electronic commerce web, etc. This embodiment is illustrated taking a page object for a product object as an example, and similar steps may be performed on page objects for other object types. The method may comprise the following steps.

Step S201 is: obtaining a data structure for data included in the page object and the data indicator item for indicating the data structure included in the page object when receiving the edit request for the page object in the web page.

Step S202 is: inputting the obtained data indicator item of the page object into the structure-editing interface to perform the edit operation on the data structure of the page object on the structure-editing interface.

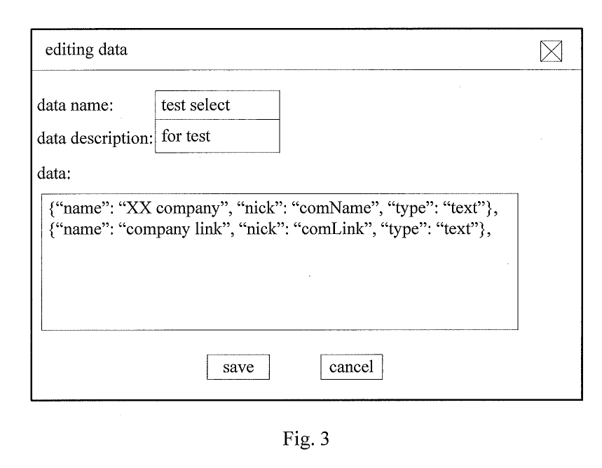

When a click from a user for editing a product object is detected, a data structure of data included in the product object is obtained to obtain a data indicator item of the page object. Meanwhile, a structure-editing interface may be called to display the obtained data indicator item. For displaying the data indicator item of the page object on the structure-editing interface, one may refer to FIG. 3, which is a structure diagram of a structure-editing interface for a page object according to one embodiment of the invention. The structure indicator included therein may be “name”, “nick”, “type”, etc, and the specific data indicator item included therein may be “XX Company”, “comName”, “text”, etc.

In step S202, performing an edit operation on the data structure of the page object on the structure-editing interface may comprise: performing any one or more of a delete operation, a modification operation, an adding operation on the input data indicator item of the page object on the structure-editing interface. For example, the structure-editing interface shown in FIG. 3 may be an interface obtained after the user deleting the item “picture” of the structure in the original data structure.

Step S201 to step S202 correspond to step S101 described above.

Step S203 is: generating, according to the data indicator item included in the structure-editing interface, a page data structure related to the page object of the web page after detecting that the edit operation is affirmed.

After the edit from the user is accomplished, and the “save” button on the structure-editing interface is clicked, the edit operation can be accomplished. The background generates a new data structure of the product object according to the data indicator items included in the structure-editing interface.

Step S204 is: introducing the page data structure into a preset objective page sheet and generating the data entry sheet, wherein the data entry sheet displays a data indicator item of the page data structure and an input indicator mark of the data indicator item.

Specifically, step S204 may comprise: calling and displaying a page establishing interface; determining the objective page sheet by selecting from at least one preset page sheet module on the page establishing interface; determining the page data structure by selecting from the page establishing interface; and generating the data entry sheet according to the objective page sheet and the page data structure selected on the page establishing interface.

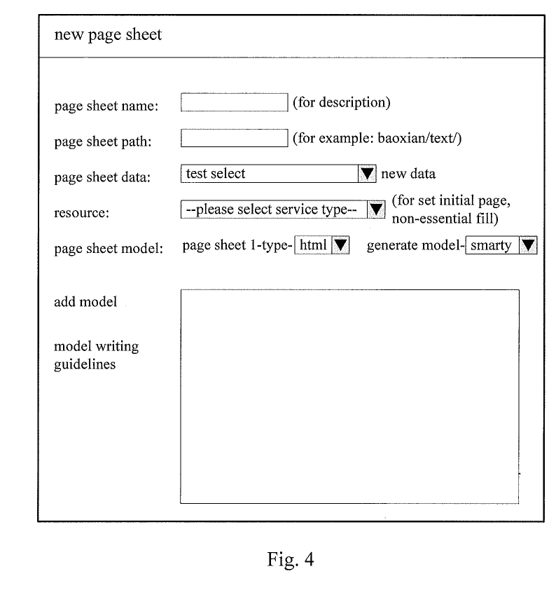

For the page establishing interface, one may specifically refer to FIG. 4. FIG. 4 is a structure diagram of a page establishing interface according to one embodiment of the invention. The “page sheet name” and the “resource” therein are used to distinct from other page sheets by inputting corresponding data from a user according to the requirement. The “page sheet path” and the “page sheet data” therein are the storage address and the name of the data structure of the page generated in step S203, respectively. The “page sheet model” indicates the user to determine an objective page sheet by selecting from at least one preset module of page sheet, the objective page sheet being used to carry the generated data structure of the page.

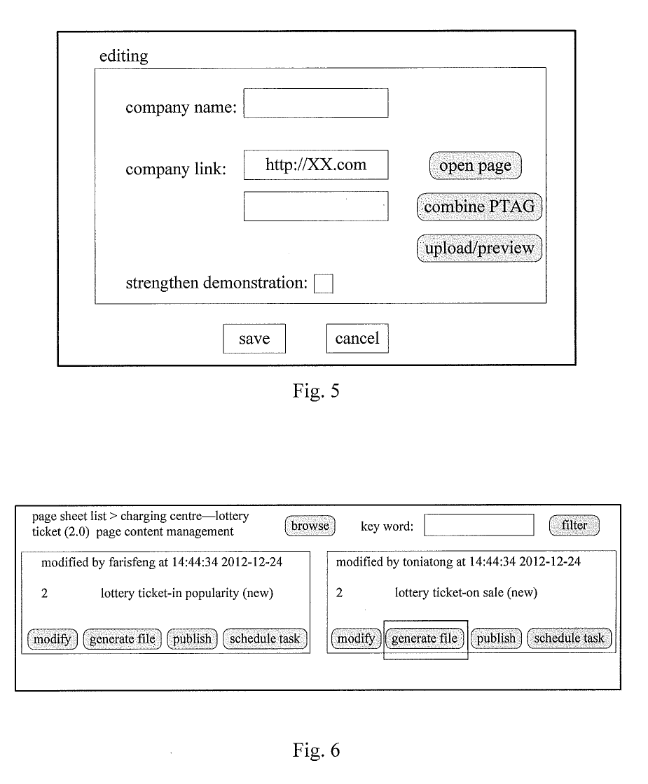

After the user clicks the save button, the corresponding data entry sheet can be generated. Its format may be specifically shown in FIG. 5, which is a structure diagram of a data entry sheet according to one embodiment of the invention. A corresponding data indicator item and an input box may be included, the input box being provided for the user to input the corresponding data.

Step S205 is: recording an input data from a user which is input in the input indicator mark of the data indicator item displayed on the data entry sheet.

Step S203 to step S205 correspond to step S102 in the embodiment described above.

Step S206 is: denoting the data entry sheet as a new page object to update the page object in the web page when detecting that data input is finished on the data entry sheet.

Data input in each of input boxes may be recorded. A new page object can be generated when the save button is clicked by the user, and the page object of the web is updated to the new page object.

Otherwise, the method can also comprise recording information of an editing user of the new page object. That is, the information such as a name of the user who performs the edit operation on the page may be recorded, which will be convenient to search the edit user at any time.

Furthermore, step S206 can specifically comprise: loading the data entry sheet into a preset edit-content management page, when it is detected that the data input in the data entry sheet is accomplished; and denoting the data entry sheet as a new page object to update the page object in the web page, when it is detected that the edit-content management page performs a publish operation on the data entry sheet.

When the “save” button on the data entry sheet shown in FIG. 5 is detected to be clicked by a user, it means the input from the user is accomplished, and then, the data entry sheet may be loaded into the edit-content management page shown in FIG. 6. When the “generate file” button in FIG. 6 is clicked by the user, a corresponding page sheet can be generated. When the “publish” button in FIG. 6 is clicked by the user, the page sheet is published to a corresponding page to update the page object in the web page. Moreover, one or more data entry sheets edited by the user may be simultaneously included in the edit-content management page shown in FIG. 5.

Based on the above description, one embodiment of the present invention may have the following benefits.

In exemplary embodiments of the present invention, a page sheet of a page object can be directly edited and generated for a data structure required by a user to replace and update an original page sheet, and it is convenient for the web maintainers to edit or modify only one or more page objects in the web page according to needs. Thus, the maintenance cost can be reduced. Moreover, since the risk of causing errors to a web is efficiently reduced, the cost can be further lowered.

A device for updating a web page according to one embodiment of the present invention will be illustrated as below.

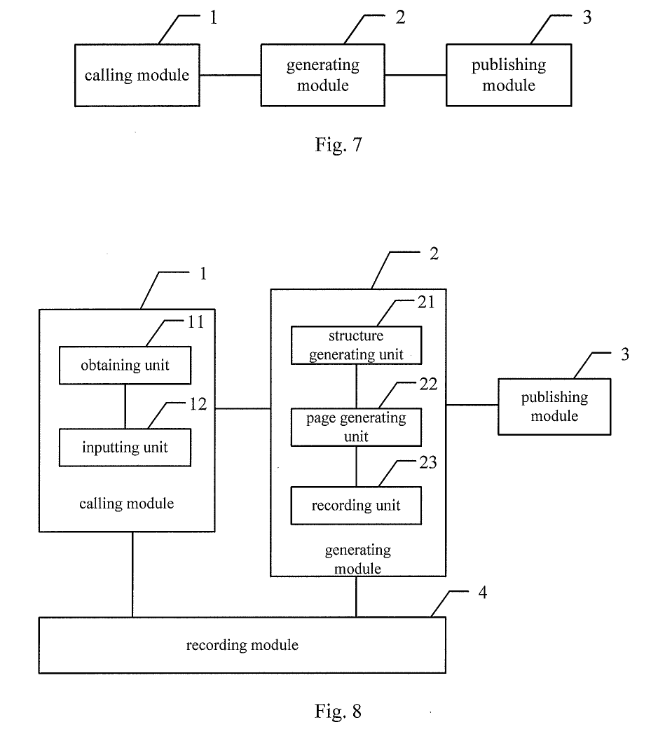

Referring to FIG. 7, it is a structure diagram of a device for updating a web page according to one embodiment of the invention. The device can be applied for page maintenance of a web, and particularly to a web in which a data structure of a page object needs to be modified, such as an electronic commerce web, etc. The device according to one embodiment of the present invention may comprise: a calling module 1 configured to call and display a structure-editing interface for a page object to perform an edit operation on the page object when receiving an edit request for the page object in the web page; a generating module 2 configured to generate, according to a data indicator included in the structure-editing interface after the edit operation is affirmed, a data entry sheet to input data corresponding to the data indicator, the data indicator being used to indicate a data structure of the page object; and a publishing module 3 configured to denote the data entry sheet as a new page object to update the page object in the web page when detecting that data input is finished on the data entry sheet.

A user may click on a page for editing product content in the web page to select a product to be edited. After the product is selected, an edit request for enabling an edit operation can be received.

The structure-editing interface called by the calling module 1 may be preset, including a name, a data instruction and a specific data indicator item. The data indicator item is used to indicate the data structure of the page object. For example, the data indicator item may indicate data as company name data, company link data or the like.

The data entry sheet in the generating module 2 may include a plurality of data indicators, and each of the data indicators corresponds to an input box which is used to suggest the user to input data. Correspondingly, the user can input a data in the input box, the data being specifically described as information of an object, such as a certain product, and so on. After the input is accomplished, the publishing module 3 may be informed. Specifically, after it is detected that all the input boxes have data input and they have been affirmed by the user clicking an input finish button, it can be determined that accomplishment of data input on the data entry sheet is detected. Then, the publishing module 3 is informed to denote the data entry sheet as a new page object.

Based on the above description, one embodiment of the present invention may have the following benefits.

In exemplary embodiments of the present invention, a page sheet of a page object can be directly edited and generated for a data structure required by a user to replace and update an original page sheet, and it is convenient for the web maintainers to edit or modify only one or more page objects in the web page according to needs. Thus, the maintenance cost can be reduced. Moreover, since the risk of causing errors to a web is efficiently reduced, the cost can be further lowered.

Referring to FIG. 8, it is a structure diagram of a device for updating a web page according to another embodiment of the invention. The device described in one embodiment of the present invention can be applied for page maintenance of a web, and particularly to a web in which a data structure of a page object needs to be modified, such as an electronic commerce web, etc. The device may comprise the calling module 1, the generating module 2, and the publishing module 3. Specifically, in one embodiment of the present invention, to perform an edit operation on the data structure of the page object on the structure-editing interface comprises: to perform any one or more of a delete operation, a modification operation, an adding operation on the input data indicator item of the page object on the structure-editing interface.

The generating module 2 of the device according to one embodiment of the present invention may specifically include: a structure generating unit 21 configured to generate, according to the data indicator included in the structure-editing interface, a page data structure related to the page object of the web page after detecting that the edit operation is affirmed; a page generating unit 22 configured to introduce the page data structure into a preset objective page sheet and generating the data entry sheet, wherein the data entry sheet displays a data indicator item of the page data structure and an input indicator mark of the data indicator item; and a recording unit configured to record an input data from a user which is input in the input indicator mark of the data indicator displayed on the data entry sheet.

Furthermore, the page generating unit 22 may specifically comprise the following sub-units: a calling sub-unit configured to call and display a page establishing interface; a determining sub-unit configured to determine the objective page sheet by selecting from at least one preset page sheet module on the page establishing interface and the page data structure by selecting from the page establishing interface; and a page generating sub-unit configured to generate the data entry sheet according to the objective page sheet and the page data structure selected on the page establishing interface.

The device according to one embodiment of the present invention may comprise the following units: an obtaining unit 11 configured to obtain a data structure for data included in the page object and the data indicator item for indicating the data structure included in the page object when receiving the edit request for the page object in the web page; and an inputting unit 12 configured to input the obtained data indicator item of the page object into the structure-editing interface to perform the edit operation on the data structure of the page object on the structure-editing interface.

The device according to one embodiment of the present invention may further comprise: a recording module 4 configured to record information of an editing user of the new page object.

Based on the above description, one embodiment of the present invention may have the following benefits.

In exemplary embodiments of the present invention, a page sheet of a page object can be directly edited and generated for a data structure required by a user to replace and update an original page sheet, and it is convenient for the web maintainers to edit or modify only one or more page objects in the web page according to needs. Thus, the maintenance cost can be reduced. Moreover, since the risk of causing errors to a web is efficiently reduced, the cost can be further lowered.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The above descriptions are some exemplary embodiments of the invention, and should not be regarded as limitation to the scope of related claims. A person having ordinary skills in a relevant technical field will be able to make improvements and modifications within the spirit of the principle of the invention. The improvements and modifications should also be incorporated in the scope of the claims attached below.

1. A method for updating a web page, comprising the steps of:
calling and displaying a structure-editing interface for a page object to perform an edit operation on the page object when receiving an edit request for the page object in the web page;
generating, according to a data indicator item included in the structure-editing interface after the edit operation is affirmed, a data entry sheet to input data corresponding to the data indicator item, the data indicator item being used to indicate a data structure of the page object; and
denoting the data entry sheet as a new page object to update the page object in the web page when detecting that data input is finished on the data entry sheet.

2. The method of claim 1, wherein the step of generating, according to the data indicator item included in the structure-editing interface after the edit operation is affirmed, the data entry sheet to input the data corresponding to the data indicator item comprises:
generating, according to the data indicator item included in the structure-editing interface, a page data structure related to the page object of the web page after detecting that the edit operation is affirmed;
introducing the page data structure into a preset objective page sheet and generating the data entry sheet, wherein the data entry sheet displays a data indicator item of the page data structure and an input indicator mark of the data indicator item; and
recording an input data from a user which is input in the input indicator mark of the data indicator item displayed on the data entry sheet.

3. The method of claim 2, wherein the step of introducing the page data structure into a preset objective page sheet and generating the data entry sheet comprises:
calling and displaying a page establishing interface;
determining the objective page sheet by selecting from at least one preset page sheet module on the page establishing interface;
determining the page data structure by selecting from the page establishing interface; and
generating the data entry sheet according to the objective page sheet and the page data structure selected on the page establishing interface.

4. The method of claim 2, wherein the step of calling and displaying the structure-editing interface for a page object to perform the edit operation on the page object when receiving the edit request for the page object in the web page comprises:
obtaining a data structure for data included in the page object and the data indicator item for indicating the data structure included in the page object when receiving the edit request for the page object in the web page; and
inputting the obtained data indicator item of the page object into the structure-editing interface to perform the edit operation on the data structure of the page object displayed on the structure-editing interface.

5. The method of claim 4, wherein to perform the edit operation on the data structure of the page object displayed on the structure-editing interface comprises:
to perform any one or more of a delete operation, a modification operation, an adding operation on the input data indicator item of the page object on the structure-editing interface.

6. The method of claim 1, further comprising:
recording information of an editing user of the new page object.

7. A device for updating a web page, comprising:
a calling module configured to call and display a structure-editing interface for a page object to perform an edit operation on the page object when receiving an edit request for the page object in the web page;
a generating module configured to generate, according to a data indicator included in the structure-editing interface after the edit operation is affirmed, a data entry sheet to input data corresponding to the data indicator, the data indicator being used to indicate a data structure of the page object; and
a publishing module configured to denote the data entry sheet as a new page object to update the page object in the web page when detecting that data input is finished on the data entry sheet.

8. The device of claim 7, wherein the generating module comprises:
a structure generating unit configured to generate, according to the data indicator included in the structure-editing interface, a page data structure related to the page object of the web page after detecting that the edit operation is affirmed;
a page generating unit configured to introduce the page data structure into a preset objective page sheet and generating the data entry sheet, wherein the data entry sheet displays a data indicator item of the page data structure and an input indicator mark of the data indicator item; and
a recording unit configured to record an input data from a user which is input in the input indicator mark of the data indicator displayed on the data entry sheet.

9. The device of claim 8, wherein the page generating unit comprises:
a calling sub-unit configured to call and display a page establishing interface;
a determining sub-unit configured to determine the objective page sheet by selecting from at least one preset page sheet module on the page establishing interface and the page data structure by selecting from the page establishing interface; and
a page generating sub-unit configured to generate the data entry sheet according to the objective page sheet and the page data structure selected on the page establishing interface.

10. The device of claim 8, wherein the calling module comprises:
an obtaining unit configured to obtain a data structure for data included in the page object and the data indicator item for indicating the data structure included in the page object when receiving the edit request for the page object in the web page; and
an inputting unit configured to input the obtained data indicator item of the page object into the structure-editing interface to perform the edit operation on the data structure of the page object displayed on the structure-editing interface.

11. The device of claim 10, wherein to perform an edit operation on the data structure of the page object on the structure-editing interface comprises:
to perform any one or more of delete, modification, add operations on the inputted data indicator of the page object displayed on the structure-editing interface.

12. The device of claim 7, further comprising:
a recording module configured to record information of an editing user of the new page object.

13. A non-transitory computer readable storage medium storing instructions that, when executed by a processor, cause the processor to implement a method of:
calling and displaying a structure-editing interface for a page object to perform an edit operation on the page object when receiving an edit request for the page object in the web page;
generating, according to a data indicator item included in the structure-editing interface after the edit operation is affirmed, a data entry sheet to input data corresponding to the data indicator item, the data indicator item being used to indicate a data structure of the page object; and
denoting the data entry sheet as a new page object to update the page object in the web page when detecting that data input is finished on the data entry sheet.

14. The method of claim 2, further comprising:
recording information of an editing user of the new page object.

15. The method of claim 3, further comprising:
recording information of an editing user of the new page object.

16. The method of claim 4, further comprising:
recording information of an editing user of the new page object.

17. The method of claim 5, further comprising:
recording information of an editing user of the new page object.

18. The device of claim 8, further comprising:
a recording module configured to record information of an editing user of the new page object.

19. The device of claim 9, further comprising:
a recording module configured to record information of an editing user of the new page object.

20. The device of claim 10, further comprising:
a recording module configured to record information of an editing user of the new page object.

21. The device of claim 11, further comprising:
a recording module configured to record information of an editing user of the new page object.
